(19) United States
(12) Patent Application Publication
(10) Pub. No.: US 2021/0285361 A1
(43) Pub. Date: Sep. 16, 2021

(54) RECIPROCATING-PISTON INTERNAL COMBUSTION ENGINE WITH DEVICE FOR INCREASING THE TORQUE THEREOF

(71) Applicant: Erwin Junker, (US)

(72) Inventor: Erwin Junker, (US)

(21) Appl. No.: 16/334,577

(22) PCT Filed: Sep. 28, 2017
(86) PCT No.: PCT/EP2017/074700

§ 371 Date: Mar. 19, 2019

(30) Foreign Application Priority Data
Sep. 30, 2016 (DE) 102016219101.2

(51) Int. Cl. F02B 21/00; F02D 13/02; F02M 23/00; F02M 23/08; F02D 41/00

(52) U.S. Cl. CPC F02B 21/00; F02D 13/0269; F02D 41/0007; F02M 23/08; F02M 23/003; F02M 23/006

(57) ABSTRACT

An internal combustion engine of reciprocating-piston type of construction is described which has a cylinder (2) with a cylinder head (1) and with an inlet valve (3) arranged in the cylinder head. An inlet line (4) is connected to the inlet valve (3), via which inlet line combustion air (5) can be fed to the cylinder (2). Furthermore, a compressed-air accumulator (6) is provided which is connected to the inlet line (4) by means of a controllable valve (7), wherein the inlet line (4) can be closed, with regard to its throughflow cross section, by means of a shut-off element (8). The valve (7) is controllable such that, on the basis of a control signal, compressed air (9) is fed from the compressed-air accumulator (6) into a region of the inlet line directly upstream of the inlet valve (3), wherein the shut-off element (8) is arranged sealingly on the cylinder head (1) and closes the cross section of the inlet line (4). The inlet valve (3) is briefly re-opened by means of an actuation element (24) during the compression stroke, and during said brief re-opening, compressed air (9) is fed from the compressed-air accumulator (6) into the cylinder (2), with the shut-off element (8) being held in its closed position. According to a second aspect, the compressed-air accumulator (6) can also be used to feed all of the combustion air to the cylinder (2) via an inlet reservoir (25) directly upstream of the inlet valve (3).

The invention concerns a reciprocating-piston internal combustion engine with the characteristics in accordance with the preamble of claim 1.

Reciprocating-piston internal combustion engines, in which combustion air can be introduced into the cylinder by way of an inlet valve arranged in the cylinder head of a cylinder, which corresponds to the principal design of a reciprocating-piston internal combustion engine, and to which a device for increasing the torque of the internal combustion engine, in the form of an additional compressed air accumulator, from which additional combustion air can also be supplied to the cylinder by way of the inlet valve that is present in the inlet line arranged the cylinder head, are generally known. The additional combustion air supplied to the cylinder by the additional pressurized container is, in accordance with the known devices, either supplied directly to the cylinder via the cylinder head and an additional air inlet valve arranged therein or by way of the inlet line before the inlet valve in the cylinder head.

According to DE 11 2007 000 944 T5, an injection of additional combustion air takes place during the compression stroke, particularly at the start of the compression stroke. The additional combustion air is made available in a compressed air tank at a pressure of about 200 bar. This makes it possible to have a positive effect on emission and, in the case of multi-cylinder machines, also on the overall performance of the internal combustion engine. However, a substantial amount of additional energy is needed for such high pressures in the pressurized tank, so as to provide a sufficiently large air volume at such a relatively high pressure.

An internal combustion engine with improved cold start behavior, in which, after drawing in and/or admitting the fuel-air mixture into the cylinder before the actual ignition process, this mixture is compressed and compressed air is then additionally introduced into the cylinder from an air reservoir is described in DE 10 2010 033 591. The cold start behavior of such a combustion engine can be thus improved, with the introduction of additional compressed air only serving the purpose of improving the cold weather start behavior.

To be able to have a positive effect on the emission and the performance of an internal combustion engine, RU 2 435 065 C2 describes a device in the case of which an additional air intake is provided in the cylinder of an internal combustion engine, by way of which compressed air from an air pressure accumulator is pushed into the cylinder after the end of ignition, in order to improve the ignition behavior and thus the performance of the engine by means of additional oxygen.

DE 10 2004 047 975 A1 describes how added air is supplied in a clocked manner during the intake stroke from an air pressure accumulator to the cylinder in the form of compressed air, with the compressed air tank of a compressed air brake being used as the compressed air tank. The overall performance of an internal combustion engine can be improved by way of the clocked injection of additional air, which is adjusted to the operating parameters of the internal combustion engine regarding the amount injected and the duration of the injection. The additional air is then supplied to the suction tube during the suction phase, which is why a relatively large air volume from the pressurized tank must be made available for each respective injection stroke.

DE 10 2012 014 204 B4 as well as DE 10 2012 014 205 B3 furthermore describe an internal combustion engine, in which additional combustion air is supplied to a cylinder from an additionally provided pressurized tank through a suction port divided into two pipe sections by way of a controllable blocking element for varying the flow cross section of one of the two subchannels. The pressurized tank is connected to the respective subchannel downstream from the controllable blocking element so that only the volume in the subchannel, but not the volume of both suction subchannels, needs to be acted upon with additional pressurized combustion air. However the subdivision of the suction port into subchannels is relatively complicated and increases the cost of such a known internal combustion engine.

DE 10 2008 000 326 A1 furthermore describes a loaded internal combustion engine, in which an additional device for injecting additional compressed air between a provided turbocharger, i.e. a compressor of the turbocharger, and the inlet valve of the internal combustion engine into the air intake system is provided. The additional compressed air is not permanently introduced in the intake stroke, but rather only if this leads to favorable performance of the vehicle depending on the current operating situation of the vehicle regarding the safety of the operator, the fuel consumption and the driving comfort, as well as the wear of the clutch. It is also necessary to inject a relatively large amount of additional compressed air in the case of this known process, since this concerns a relatively large volume, which leads to rapid consumption of the combustion air stored in an additional compressed air tank.

DE 102 24 719 B4 describes an internal combustion engine in which a pressure accumulator is also provided, by means of which valves are controlled via an engine control device, in order to pressurize the intake system of the internal combustion engine in a clocked manner with additional combustion air. The pressurization of the entire intake system with additional pressurized combustion air is then considered to be disadvantageous because of the magnitude of the volume of the intake system, because this would require a very voluminous pressure vessel. However, to avoid this problem, an additional, smaller suction manifold, by way of which the additional combustion air is supplied to the actual intake system shortly before the intake into the cylinder, is used as a remedy. The air pressure accumulator is now connected to this additional air intake system. This complicates the entire piping system needed for the internal combustion engine, which is contrary to the requirement for high compactness of such an internal combustion engine, e.g. in a passenger car, and which additionally increases the complexity of the structure and thus the cost of such an internal combustion engine.

A boost for an exhaust turbocharging internal combustion engine is additionally known from DE 39 06 312 C1. The boost consists of providing an additional compressed air tank, from which pressurized combustion air is injected into the respective cylinders. The pressure in this compressed air tank is in the range of 5 bar, with the air injection being clocked so that, for example, additional fuel is not immediately introduced into the cylinder when stepping on the gas pedal, but rather the additional air is injected first and the amount of fuel is only increased thereafter. An automatic valve for supplying the suction tube of the internal combustion engine with additional supercharged air is provided for this purpose. The additionally present automatic valve is then located at the entry into the intake air collecting line, rather than in the proximity of the respective cylinder, so that a relatively large air volume is needed in order to increase the pressure in the inlet air collecting line.

DE 10 2008 000 324 A1 also describes an internal combustion engine with a device for injecting additional compressed air into an air intake system between a turbocharger, i.e. the compressor of the turbocharger, and the direct inlet in the region of the inlet valve into the cylinder head of the internal combustion engine. Compressed air additionally injected into the air intake system is controlled regarding the time, duration, pressure and/or volume, depending on the required performance of the internal combustion engine, its load condition, the vehicle speed and the operational procedures for a change in the transmission gearbox. Compressed air is injected into the suction manifold so that a relatively large volume of air is required. The duration of the air injection is at best determined based on the position of the butterfly valve.

And lastly, an internal combustion engine with an air intake system of a turbocharged engine, in which an air damper is provided between the compressor of the exhaust gas turbocharger and the inlet into the cylinder, by means of which air damper some degree of sealing of the suction manifold is to be achieved in the direction of the compressor of the exhaust gas turbocharger, is known from U.S. Pat. No. 3,673,796. Since this air damper is located in the proximity of the compressor, the volume of the suction manifold between the damper and the inlet valve is still quite large, so that such a device requires a voluminous pressure vessel for the combustion air that is additionally to be made available.

As compared with the known devices, the object of this invention consists of building a reciprocating piston internal combustion engine with higher torque, which has a simple design and ensures a reliable supply of the cylinders with additional combustion air, while the internal combustion engine nevertheless has a high degree of compactness and occupies an insignificant amount of additional space in view of its dimensions.

This task is achieved by means of an internal combustion engine of the reciprocating piston design with the characteristics in accordance with claim 1. Expedient additional embodiments are defined in the dependent claims.

The reciprocating piston internal combustion engine of this invention has at least one inlet valve arranged in the cylinder head of a cylinder to which an inlet manifold is connected. Combustion air is supplied to the cylinder by way of the inlet manifold. In the case of a suction machine the combustion air is drawn in via the inlet manifold, while in the case of a loaded machine the combustion air is supplied to the cylinder via a loading device, usually in the form of a compressor driven by an exhaust-gas turbine. A compressed air accumulator, which is connected to at least a part of the inlet manifold via a controllable valve, is additionally provided. So that compressed air, which is supplied to the cylinder by a compressed air accumulator of the inlet manifold and thus by way of the inlet manifold, does not have to fill the entire larger volume of the inlet manifold, the inlet manifold has a blocking device, by means of which the flow-through cross section of the inlet manifold can be blocked. The volume of the inlet manifold into which compressed air from the air pressure accumulator is supplied is thus substantially reduced as compared to the entire inlet manifold. At least a part of the pressure prevailing in at least a part of the inlet manifold is increased above the pressure which is otherwise present e.g. due to a compressor of an exhaust gas turbocharger functioning as a charging device. This pressure in the inlet manifold that is increased with additionally supplied compressed air leads to a higher density of the supplied air and thus to an increased oxygen supply in the combustion chamber of the cylinder.

The valve, by way of which compressed air from the compressed air accumulator is supplied, can be controlled so that compressed air from the compressed air accumulator is supplied by means of control equipment based on a control signal to the domain of the inlet manifold in which the inlet valve is located. This means that compressed air is supplied by the compressed air accumulator as close as possible to the cylinder. The blocking device is now configured so that the region of the inlet manifold to which compressed air is supplied by the compressed air accumulator is essentially limited to only a part of the inlet manifold when the blocking device is closed, i.e. when the flow-through cross section of the inlet manifold is blocked. The blocking device is thus located as close as possible to the inlet valve. The blocking device is preferably arranged in the part of the inlet manifold at which the inlet manifold is itself connected to the cylinder head. The inlet valve is usually controlled by a control element, preferably a cam on a camshaft regarding its movement. According to this invention, the shape of the cam is modified so that, during the compression stroke, the inlet valve can be briefly returned to an open position, during which compressed air from the pressure accumulator, which is additionally used as combustion air, can be brought into the cylinder via the control valve and while the blocking device is in the blocking, closed position, which closes off the flow-through cross section of the inlet manifold.

The additional blocking device makes it possible for the additional compressed air from the compressed air accumulator to only be fed into a relatively small volume of the inlet manifold, so that the compressed air present in the compressed air accumulator can be made available for as large a number as possible of combustion processes in the cylinder. The smaller and/or reduced space also owes its temporally faster introduction into the cylinder to the compressed air as a compressible medium and, for this reason, has a favorable effect in filling the cylinder. In doing so, the blocking device and the valve are accordingly controlled in a synchronized manner by the control equipment. The blocking device can then preferably be actively controlled; but it can also be at least partly controlled by means of the kinetic energy of the flowing combustion air.

The blocking device is preferably designed as a compressed air controlled flap valve that is movable between two positions. If the case of an open, controlled valve, such a flap valve is movable into a position closing the inlet manifold by way of the kinetic energy of the combustion air and/or compressed air from the compressed air accumulator with a higher pressure than that which is usually present. If the blocking device is moved into the position blocking the flow through the cross section of the inlet manifold, the blocking device is held in the closed position for a sufficiently long time due to the compressed air supplied via the open valve, until the supply of additional compressed air into the blocked part of the inlet manifold is interrupted, whereby, at the start of the next intake and/or induction stroke, the kinetic energy of the combustion air again moves the flap valve into an open position releasing the inlet manifold. If the kinetic energy of the combustion air does not suffice, an additional means can be provided, via active actuation equipment, for moving, in particular swiveling, the blocking device between its open and its closed position.

Such an actuator is preferably operated electrically, magnetically or by a combination at least two of these drive types.

The inlet valve is preferably controlled on the basis of its preferably cam-controlled drive, depending on the motion of the flap valve, in such a manner that it opens only after the flap valve has been moved into its closed position and closes, before the flap valve has been returned to its open position.

The cam on the camshaft, which controls the inlet valve, preferably has an additional opening ramp, by means of which the inlet valve is reopened during the compression stroke. The opening of the inlet valve is then obviously controlled so that it only opens during a phase of the compression stroke during which the pressure in the cylinder is lower than the pressure of the compressed air in the pressure accumulator.

But it is possible for an additional cam to be provided on the camshaft for the purpose of causing the inlet valve to open again. This cam can preferably also be configured as a slanted cam, so that, depending on the respective load of the engine, the opening and closing times of the inlet valve for reopening during the compression stroke are changeable.

The additional compressed air in the pressure accumulator preferably has a pressure in the range of 10 to 15 bar, but the pressure can also be higher, in particular in a range of 10 to 30 bar.

The valve for controlling the compressed air in the region of the inlet manifold before the inlet valve, which valve is positioned between the blocking device configured as a flap valve and the inlet valve, is preferably controllable in such a way that the compressed air can be supplied to the inlet manifold depending on of the engine operating parameters such as e.g. the engine load.

In accordance with a second aspect of the invention, an internal combustion engine of the reciprocating piston type is likewise provided with at least one inlet valve arranged in a cylinder head of a cylinder to which an inlet reservoir is connected. The combustion air is supplied to the cylinder by way of the inlet reservoir, in particular by a pressure accumulator, which is directly connected to the inlet reservoir via a controllable valve. The volume of the inlet reservoir is smaller than the usual volume of an entire inlet manifold, which is nevertheless large enough in conventional internal combustion engines to allow a sufficient amount of combustion air to be supplied to the respective cylinder depending upon the load condition of the combustion engine. According to this invention, the valve is controllable in such a manner that, based on a control signal, combustion air from the pressure accumulator can be supplied into a region of the inlet reservoir in the cylinder head in which the inlet valve is located. i.e. the valve is located in the immediate proximity of the inlet valve in the cylinder head, but it is not located in the cylinder head. This design makes it possible to use conventional designs of cylinder heads and to possibly reconfigure existing engines to such a design where the combustion air is supplied from a pressure accumulator without having to adopt an entirely new engine design. The inlet valve is preferably controlled by means of a controlling element, preferably a cam, preferably a camshaft, regarding its necessary movement, with the controlling element being configured so that the inlet valve can be returned to its open setting during the compression stroke of the internal combustion engine, during which combustion air from the pressure accumulator can again be fed into the cylinder via the controlled valve, and is again closed before the end of the compression stroke, so that the pressure existing in the cylinder still does not exceed the pressure in the pressure accumulator.

The internal combustion engine is described using the example of valve control via a camshaft. However the valve control is not limited to camshafts. Other valve controls, such as e.g. electrical, electromagnetic or hydraulic valve controls, are conceivable.

Additional benefits, details and designs of the internal combustion engine according to this invention are hereinafter described in detail with reference to the drawings, which show:

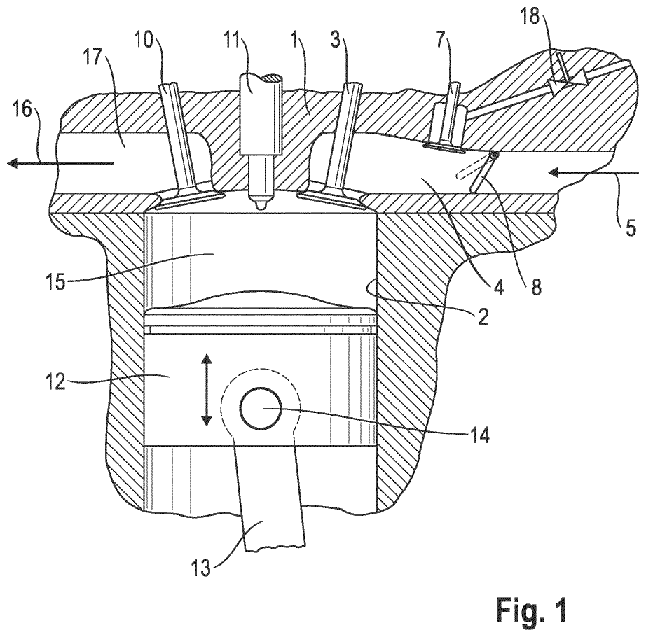

FIG. 1: a basic cross section of the cylinder of an internal combustion engine with a controllable valve in the inlet manifold for supplying additional compressed air from a compressed air accumulator in accordance with this invention;

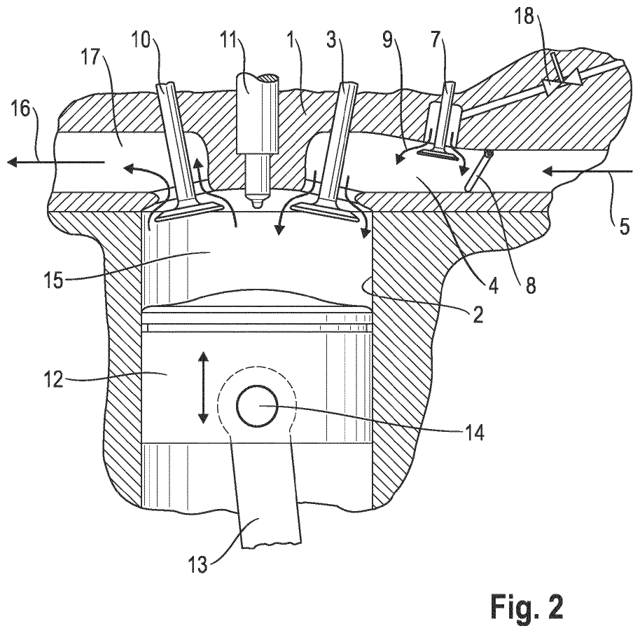

FIG. 2: a view in accordance with FIG. 1, wherein the inlet valve and the exhaust valve are shown in their valve overlapping phase and the controllable valve for supplying compressed air from the compressed air accumulator is in its open position;

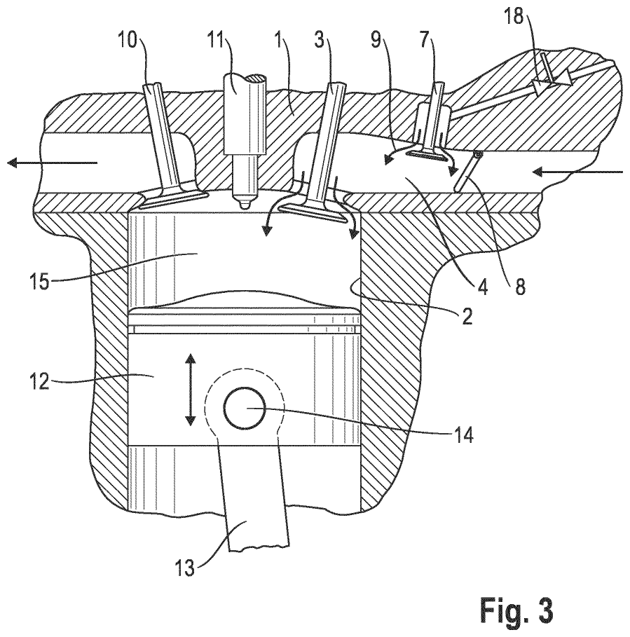

FIG. 3: a view in accordance with FIG. 1, wherein the reopening of the inlet valve for supplying compressed air from the compressed air accumulator while the inlet manifold closed off is shown;

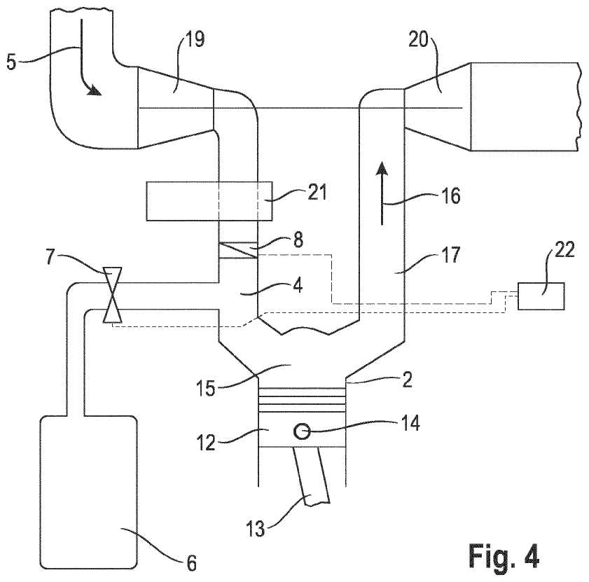

FIG. 4: a basic diagram of a combustion engine with a charged exhaust air turbocharger with an additional compressed air accumulator for supplying compressed air used as additional combustion air into the inlet manifold of the internal combustion engine;

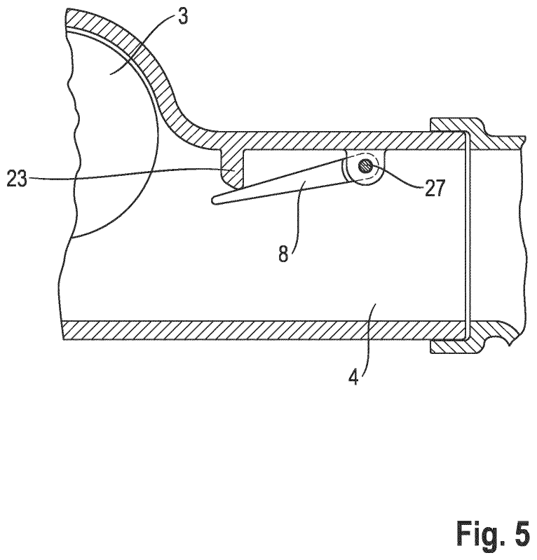

FIG. 5: a region of the inlet manifold of the internal combustion engine immediately before the inlet valve, with the blocking device open for supplying combustion air to the inlet valve via the inlet manifold;

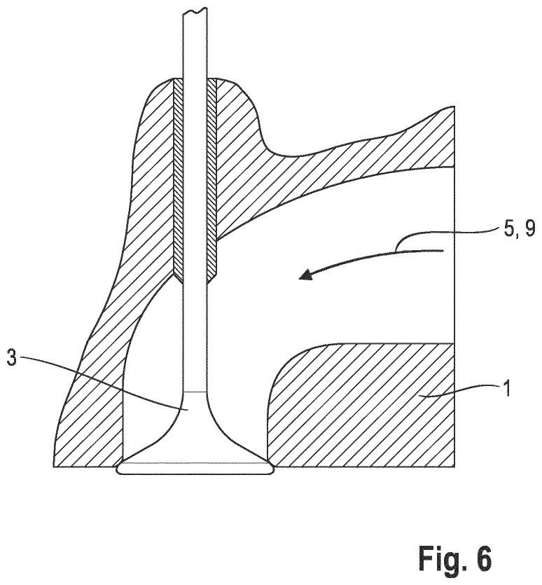

FIG. 6: a section of the cylinder head of an internal combustion engine with a closed inlet valve and suggested feed of combustion air from the loading system of the internal combustion engine and/or compressed air from the pressure accumulator; and

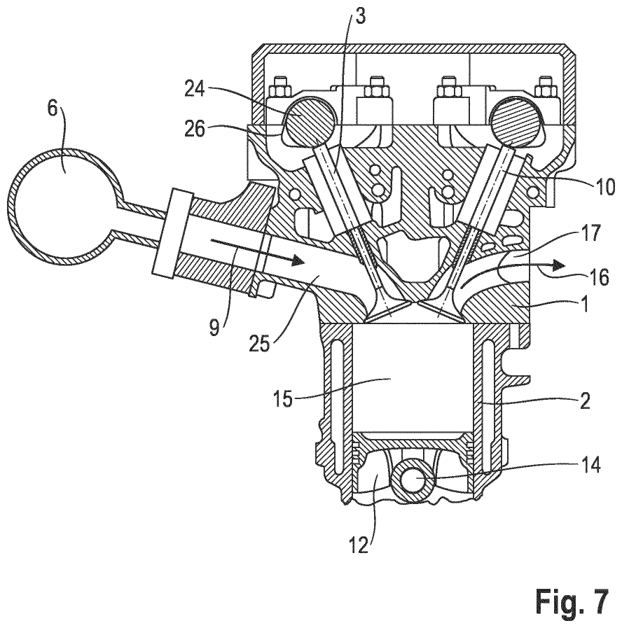

FIG. 7: a general cross sectional view of an internal combustion engine in accordance with this invention, wherein all of the combustion air is supplied to the cylinder and/or the combustion chamber from a compressed air accumulator.

FIG. 1 shows a basic cross section of a cylinder 2 with a cylinder head 1 and a suggested piston 12 in the cylinder of an internal combustion engine with an inlet valve 3 and an exhaust valve 10 as well as a fuel injection nozzle 11 in the cylinder head 1. The inlet valve 3 is shown in its position in which a combustion chamber 15 of the cylinder 2 is sealed off from the inlet manifold 4. The exhaust valve 10 is also shown in its position sealing off the exhaust 17 from the combustion chamber 15 of the cylinder 2. The piston 1, which is configured as a plunger piston and is connected to a piston pin 14 by way of a piston rod 13, usually moves between a lower and an upper dead center position. This motion is suggested by the double arrow in the piston 12. A controllable valve 7 is arranged in the inlet manifold 4, which valve 7 is connected by way of a pipe having a shut-off valve 18 located therein to a pressure accumulator not shown in FIG. 1. The controllable valve 7 is shown in FIG. 1 in its closed position.

The arrow shown in the inlet manifold 4 represents the combustion air 5 conveyed by a loading system into the inlet manifold 4. Because of the kinetic energy of the combustion air 5, a blocking device 8 in the form of a flap valve is moved from the position shown in FIG. 1, which closes off the cross section of the inlet line 4, into the opening up position represented by dashed lines. Depending upon the kinetic energy of the combustion air 5 flowing into the inlet manifold, this flap valve can be fully opened so as to essentially fully release the cross section of the inlet manifold 4.

As shown in FIG. 1, the piston 12 is in its working stroke, in which the inlet valve 3 and the exhaust valve 10 are closed. It is during the working stroke that the fuel previously injected via the fuel injection nozzle 11 is burned, so that the piston 12 can carry out its working stroke and, in doing so, can move from the upper dead center in the direction of the lower dead center.

FIG. 2 shows a basic representation of a cylinder 2 with a cylinder head 1 of an internal combustion engine in accordance with FIG. 1, in which the piston 12 has moved somewhat from the lower dead center in the direction of the upper dead center, where the start of the compression stroke is characterized by the valve overlap phase, in which the inlet valve 3 is open and the exhaust valve 10 is still open. Combustion air 5 therefore flows from the inlet manifold 4 into the combustion chamber 15 in order to support an outflow of combusted air via the opened exhaust valve 10 into the exhaust line 17 as exhaust gas 16 from the combustion chamber 15, so as to be able to realize as complete a removal as possible of fully combusted gases from the combustion chamber 15.

The same reference numbers are used for the same components and parts, so that their meaning is not repeated here in every case. With the shut-off valve 18 open, the compressed air 9 is directly supplied from the not shown compressed air accumulator, by way of the valve 7, into the region of the inlet manifold 4 before the inlet valve 3. The pressure in the compressed air accumulator is usually noticeably higher than the pressure of the combustion air 5 produced in the inlet manifold 4 by the loading device. If compressed air 9 is therefore supplied by way of the valve 7 directly into the region of the inlet manifold 4 immediately before the inlet valve 3, the blocking device 8 closes, in fact against the effect of the kinetic energy of the flowing combustion air 5. It is with this additional compressed air 9 that a not insignificant reloading effect of the cylinder and/or combustion chamber 15 is thus achieved. The control of the inlet valve 3, the valve 7 and the exhaust valve 10 is then synchronized so that this reloading effect takes place without the compressed air that is additionally supplied into the inlet manifold 4 under increased pressure and into the combustion chamber 15 via the inlet valve 3 being able to escape by way of the exhaust valve 10. The exhaust valve 10 is thus closed in time for the intensified loading of the cylinder 2 with fresh air before the inlet valve 3 closes again.

It is an advantage of such an arrangement that, for example in the event of a malfunction of the loading device, the blocking device 8 preferably actively operating in its closed position ensures that the volume of this part of the inlet manifold 4, which is to be filled with compressed air from the compressed air accumulator and is located near the inlet valve 3, can be kept relatively small so as to just fill the cylinder with combustion air 9 in the form of compressed air from the compressed air accumulator.

This design in accordance with this invention is particularly advantageous if, for a desired reloading effect, additional compressed air 9 from the compressed air accumulator 6 (see FIG. 4) is nevertheless additionally supplied to the inlet manifold 4 and thus to the cylinder 2, i.e. the combustion chamber 15, by way of the valve 7. Control of the valve 7 can then be achieved depending on the respective load conditions of the internal combustion engine.

FIG. 3 now provides a representation of an internal combustion engine in accordance with FIG. 1, i.e. of its cylinder 2 and cylinder head 1, with which the phase when compression begins, i.e. the upward motion of the piston 12 from the lower dead center in the direction of the upper dead center, has begun and has been achieved insofar as the exhaust valve 10 is already closed and the pressure in the combustion chamber 15 is still below the pressure in the compressed air accumulator 6. In this condition, the inlet valve 3, after it has already been filled with combustion air 5 coming from the loader for purposes of normally filling the combustion chamber 15 with fresh air, is again briefly opened, with this brief opening being shown in FIG. 3, so that, with the valve 7 open and the blocking device simultaneously closed, additional compressed air 9 can be introduced into the cylinder 2 by the compressed air accumulator 6 in the sense of a reloading effect. The additional compressed air 9 ensures a higher proportion of oxygen provided for combustion, so that the torque and thus the performance of the internal combustion engine can be increased according to the adjusted amount injected.

FIG. 4 provides a general representation of the design of a combustion engine with exhaust gas turbochargers 19, 20 and intercoolers 21 as well as an additionally present compressed air accumulator 6 for reloading the cylinder 2 of the internal combustion engine in accordance with this invention. In doing so, fresh air is drawn in as combustion air 5, it is compressed in the compressor 19 and it is back-cooled by intercoolers 21 located in the inlet manifold 4 in order to increase the density of the combustion air 5 via a compressor 19 of the exhaust gas turbocharger consisting of this compressor 19 and an exhaust-gas turbine 20. The combustion air 5 then continues to flow in the blocking device 8 in the direction of the not represented inlet valve into the combustion chamber 15 of the cylinder 2, which is limited in the downward direction by the piston 12, which is connected to a not represented crankshaft via a connecting rod 13 linked to a piston pin 14. The compressed air accumulator 6, which is connected to the inlet manifold 4 by way of a link from a shutoff valve 18 is additionally shown. A control device 22 operates the controllable valve 7 and the blocking device 8 in such a manner that either additional compressed air 9 from the compressed air accumulator 6 can be supplied in the sense of a reloading effect into the inlet manifold 4 and thus into the cylinder in the combustion chamber 15, so that the torque of the internal combustion engine can be increased with a corresponding increase of the amount injected, or all of the combustion air from the compressed air accumulator 6 is supplied to the cylinder 2 if the blocking device 8 closes the cross section of the inlet manifold 4. The latter method can above all be applied if, for example, the exhaust gas turbocharger 19, 20 is out of commission, which can accidentally happen in case of failure of e.g. the compressor 19. The exhaust-gas turbine can nevertheless operate in such an event and its energy can, for example, be used for supplying the compressed air accumulator 6 by means of a not represented additional compressor. The control device 22 thus operates the controllable valve 7 and the blocking device 8 in mutual dependence and depending on the demanded or desired performance of the internal combustion engine.

FIG. 5 provides a basic view of the region of the inlet manifold 4, which is located immediately adjacent to the inlet valve 3, whose valve disk is shown. A blocking device 8 is shown in FIG. 5, which is arranged in its open position, which unblocks the cross section of the inlet manifold 4. In this position, combustion air, which is, for example, conveyed by a loader, can be conveyed into the cylinder by means of the inlet manifold 4 and the inlet valve 3 so as to supply of the combustion chamber with fresh air. The blocking device 8 can, for example, be designed so that the kinetic energy of the inflowing combustion air moves the blocking device 8 designed as flap valve and thus releases the flow cross section for the combustion air in the direction of the cylinder.

According to this invention, compressed air 9 from a compressed air accumulator 6 is additionally supplied in the domain of the inlet valve 3 by way of a controllable valve 7. This controllable valve 7 is not shown in FIG. 5 for the sake of simplicity. The pressure in the compressed air accumulator 6 is in each case higher than the pressure of the combustion air produced by the loader in the inlet manifold 4. It is by this means that, with the controllable valve 7 open, that the blocking device 8 is swiveled, even counter to the kinetic energy of the flowing combustion air 5, into its closed position, in which the cross section of the opening is essentially completely closed. It is however also possible that the blocking device 8 can be actively operated by means of an actuator 27. If the actuator 27 has moved the blocking device 8 into its closed position or if the increased pressure of compressed air 9 from the reservoir 6 caused the blocking device 8 to swivel into its closed position, it is either possible for the cylinder 2 to be completely filled with compressed air 9 from the compressed air accumulator 6, or additional compressed air can be supplied to the cylinder 2 via the reopened inlet valve 3 for a reloading effect during the compression stroke of the piston 12.

FIG. 6 shows an inlet valve 3 in the cylinder head 1 with the combustion air 5 coming from an inlet manifold 4 and/or compressed air 9 coming from a compressed air accumulator 6 (not represented). FIG. 6 only shows the elbow of the final part of the inlet manifold 4, i.e. of the region, which leads directly to the inlet valve 3. In accordance with this invention it is also possible for a compressed air tank 6 be directly connected to this intake manifold in the cylinder head 1, which compressed air tank 6 provides all of the combustion air for the combustion process in the cylinder 2 of an internal combustion engine.

FIG. 7 shows such an example embodiment in for an internal combustion engine according to this invention in cross section. In the usual way, the piston 12, which seals the combustion chamber 15 on the bottom side, is shown with its piston pin 14, while both the inlet valve 3 and the exhaust valve 10 in the cylinder head, which closes the top of the combustion chamber 15, are respectively shown in the closed position. Combusted exhaust gas can leave the cylinder 2 after completion of the working stroke via the exhaust 17 with the exhaust valve 10 open. This is represented by the arrow 16. A compressed air accumulator 6, which supplies an inlet reservoir 25 directly with compressed air 9 just before the inlet valve 3 is shown right next to the region of the inlet valve 3. The compressed air 9 can therefore be introduced into the cylinder 2 of the internal combustion engine when the inlet valve 3 is open. This can be done during the entire gas exchange process as well as during a reloading phase with inlet valve 3 reopened during the compression stroke. The inlet valve 3 is operated by a cam 24, which sits on a not shown camshaft. This cam additionally has an opening ramp, with which a reopening is implemented during the compression phase. It is however also possible to provide a separate cam on the camshaft for repeated opening, which is however not shown in FIG. 7.

### REFERENCE NUMBER LIST

1 Cylinder head
2 Cylinder
3 Inlet valve
4 Inlet manifold
5 Combustion air
6 Compressed air accumulator
7 Valve
8 Blocking device/flap valve
9 Compressed air
10 Exhaust valve
11 Fuel injection nozzle
12 Piston
13 Piston rod
14 Piston pin
15 Combustion chamber
16 Exhaust gas
17 Exhaust
18 Shut-off valve
19 Compressor
20 Turbine
19, 20 Exhaust gas turbochargers
21 Intercooler
22 Control device
23 Impact blocking device
24 Cam inlet valve
25 Inlet reservoir
26 Opening ramp
27 Actuator blocking device

1-11. (canceled)

12. Internal combustion engine of the reciprocating piston type with just one intake valve, located in the cylinder head of a cylinder to which an inlet manifold is attached, by way of which combustion air can be supplied to the cylinder, with a compressed air accumulator, from which compressed air can be fed into the cylinder of the internal combustion engine by way of a controllable valve,
characterized in that,
the internal combustion engine has a blocking device in the inlet manifold for purposes of closing the flow-through cross section of the inlet manifold,
the valve and the blocking device are controllable in mutual dependence and depending on the demanded performance of the internal combustion engine in such a manner that, based on a control signal, either additional compressed air from the compressed air accumulator can be supplied to a region of the inlet manifold within which the intake valve is located and is essentially restricted to the cylinder head when the blocking device is in its closed position, and whose torque can be increased when the amount injected is increased,
the intake valve can be briefly reset to its open position during the compression stroke by means of a control element defining its movement, during which compressed air from the compressed air accumulator can be fed into the cylinder via the controlled valve, and the blocking device is in its closed position, or in the event of malfunction of a compressor of an exhaust gas turbocharger having a compressor and an exhaust-gas turbine, the cylinder can be supplied all of the combustion air from the compressed air accumulator and the exhaust-gas turbine then drives an additional compressor so as to supply the compressed air accumulator.

13. Internal combustion engine according to claim 12, characterized in that the blocking device is a compressed air-controlled flap valve that is movable between two positions, with the blocking device, when the controllable valve is open, being movable into a position in which the inlet manifold is blocked by the kinetic energy of the compressed air coming from the compressed air accumulator, whose pressure is higher than that in the inlet manifold, and holding it there, and when the controllable valve is closed, the kinetic energy of the combustion air existing in the inlet manifold being movable to an open position releasing the inlet manifold.

14. Internal combustion engine according to claim 12, characterized in that the flap valve can be moved, in particular can be swiveled, from its open position into its closed position and vice versa via a controllable actuator.

15. Internal combustion engine according to claim 14, characterized in that the actuator is electrically, magnetically operable or by combination at least two of these drive systems.

16. Internal combustion engine according to claim 12, characterized in that the inlet valve is controllable in a manner such that it only opens after moving the blocking device into its closed position and only closes before moving the blocking device into its open position.

17. Internal combustion engine according to claim 12, characterized in that an additional opening ramp for repeated opening the inlet valve is provided at the controlling element which operates the inlet valve in the form of a cam of a camshaft.

18. Internal combustion engine according to claim 12, characterized in that a separate cam is provided on the camshaft for repeated opening of the inlet valve.

19. Internal combustion engine according to claim 12, characterized in that the blocking device is located in the cylinder head near the inlet area of the inlet manifold.

20. Internal combustion engine according to claim 12, characterized in that a pressure of 10 to 15 bars prevails in the compressed air accumulator.

21. Internal combustion engine according to claim 12, characterized in that the supply of compressed air into the valve is located between the blocking device and the inlet valve, which controls the inlet manifold.

22. Internal combustion engine according to claim 12, characterized in that, depending on engine operating parameters, compressed air can be supplied to the inlet manifold by means of the controllable valve.
